(19) United States
(12) Patent Application Publication
(10) Pub. No.: US 2015/0202101 A1
(43) Pub. Date: Jul. 23, 2015

(54) ASYMMETRICAL WHEEL KIT FOR MANUAL WHEELCHAIR AND WHEELCHAIR FITTED WITH SAID WHEEL KIT TO FACILITATE THE PRACTICE OF A THROWING SPORT

(71) Applicant: UNIVERSITÉ DE TOULON, La Garde (FR)

(72) Inventors: Nicolas Louis, Hyeres (FR); Philippe Gorce, La Valette (FR)

(73) Assignee: UNIVERSITÉ DE TOULON, La Garde (FR)

(21) Appl. No.: 14/425,141

(22) PCT Filed: Sep. 3, 2013
(86) PCT No.: PCT/IB2013/002623

§ 371 Date: Mar. 2, 2015

(30) Foreign Application Priority Data
Sep. 3, 2012 (EP) 12368023.3

(51) Int. Cl. A61G 5/02

(52) U.S. Cl. CPC A61G 5/028; A61G 5/024

(57) ABSTRACT

The present invention relates to an asymmetrical wheel kit for a manual wheelchair (1), and a wheelchair fitted with the wheel kit to facilitate the practice of a throwing sport activity. The wheel kit is characterized in that it includes two asymmetrical wheels, with a small lateral wheel (10) and a large lateral wheel (42), the small lateral wheel (10) being provided with drive means (24-1, 24-2, 25-1, 25-2, 26, 27, 40, 47; 55, 56a, 56b, 54) actuated by a first actuation means (43) arranged on the side of the large lateral wheel (42). This kit can be used in the field of manual wheelchairs for sick or disabled persons.

The present invention relates to an asymmetrical wheel kit for a manual wheelchair and a wheelchair fitted with said wheel kit to facilitate the practice of a throwing sport.

Various types of manual or motorized wheelchair have been known for the transportation of disabled or sick persons. In France, the prevalence of the disabled persons having a wheelchair is of about 1% of the population. In Britain and in the United States of America, it is comprised between 2 and 4% of the population. This corresponds to several million persons.

An example of a manual wheelchair is known in particular from FR-A-2,731,898. This document describes a manual wheelchair, which conventionally comprises two large driving wheels arranged on either side of the wheelchair's seat, with a small auxiliary wheel also being provided on each lateral side near to the front of the wheelchair.

The large lateral driving wheels can be rotated by means of a handrim associated with each of the large wheels, both for forward and backward movements. For example, it is possible to make the wheelchair turn on the spot by actuating one of the handrims, and therefore one of the lateral wheels, in one direction, while actuating the other handrim and therefore the other lateral wheel, in the opposite direction. Conventionally, this can be done by arranging the handrim near to the large lateral driving wheel with which it is associated.

Since the wheelchair occupant may however be a person having only one useful arm, with the inability to move his/her other arm, for example a hemiplegic person, or a person with no arms or one useful arm, according to the aforementioned document, both handrims are arranged on only one lateral side of the wheelchair, so that the occupant can operate these with his/her single useful arm.

Moreover, this document shows that it is possible to provide a kit comprising large lateral driving wheels with a quick-release and hinged hub assembly so that, on the one hand it can be placed in a retracted position in which the unused wheelchair is folded, by folding its lateral sides on top of each other, and/or, on the other hand, it can be adapted to different types of manual wheelchair.

In recent years, many initiatives have been taken to allow disabled persons to be integrated as well as possible into society and therefore to practice various activities which were previously reserved for those considered to be in good health.

This applies to sports activities, which are a strong social integration vector for disabled persons, thus contributing to the development of a so-called disability sport combining different types of sports.

In this context, it was noticed that there was a strong demand from disabled persons to participate in various throwing activities, such as, for example, but not limited to bowling, bowls, curling, etc.

However, it was found that a conventional manual wheelchair was poorly suited to the practice of throwing activities. The disabled person sitting in the wheelchair and practicing throwing sports can easily be injured when throwing, by bumping, for example, into the large lateral driving wheel of the wheelchair and/or its handrim situated on the side corresponding to that of the throwing hand and to the trajectory of the arm performing the throwing action. These injuries, for example to the hand, and more precisely, the fingers, have very serious consequences, since the arms and hands of the wheelchair's occupant are constantly used, in particular to ensure his/her movements by pushing on the handrims.

Moreover, if the disabled person wishes to avoid the risk of injury by keeping his/her throwing hand away from his/her body, so that the throwing trajectory does not interfere with the large lateral wheel arranged on the throwing side, the throwing movement becomes less accurate and the sporting activity looses its appeal. This affects the psychology and well-being of the wheelchair's occupant, whose very need is to ensure that he/she is able to practice various sports activities without any discomfort.

No prior-art document has addressed the possible adaptation of a manual wheelchair to the practice of throwing sports activities.

The closest state of the art is disclosed in JP-A-2010/227478, which relates to a manual wheelchair having a large-diameter lateral wheel associated with a small-diameter lateral wheel arranged on the other lateral side of the wheelchair. The small-diameter wheel does not exceed the height of the wheelchair seat. The large lateral wheel only is associated with a handrim. The small-diameter wheel can be mounted on either the left or the right side of the wheelchair.

The purpose of the aforementioned document is to allow a disabled person to leave his/her wheelchair in order to lie on a bed or a sofa. The small wheel has no handrim, such that the wheelchair is an indoor wheelchair with highly reduced mobility. In fact, it is the person sitting in the wheelchair who can steer the latter over small distances by pushing on the floor with his/her foot. In the case of this document, the thus modified manual wheelchair becomes an indoor wheelchair with highly reduced mobility.

Such a wheelchair is not at all suited to outdoor sporting activities, in particular throwing activities, since such activities require frequent displacements, the purpose of such activity being that the wheelchair occupant has the impression of being able to freely and fully practice a sport without feeling that he/she is physically hindered or limited by his/her equipment. Moreover, in this document, although the small lateral wheel is less cumbersome than a large lateral wheel, the small wheel can nevertheless still interfere with the trajectory of the throwing arm and cause discomfort to the person performing the throwing action.

The basic problem to be solved by the present invention is to allow a manual wheelchair to be adapted to the practice of throwing sports by its occupant, with the occupant's arm no longer being hindered during the throwing action, whilst at the same time substantially preserving all functionalities of the wheelchair, with the manual wheelchair additionally being straightforward to convert into a wheelchair specifically adapted to throwing sports and vice versa.

For this purpose, according to the present invention, a wheel kit is provided to form the lateral drive wheels of a manual wheelchair, the kit including a wheel arranged close to each of its longitudinal ends, the wheels being connected together by a mechanical linkage, a connection piece being provided near to each wheel for connecting the kit to a respective lateral side of the wheelchair, characterized in that it includes two asymmetrical wheels, with a small lateral wheel and a large lateral wheel, the small lateral wheel being provided with drive means actuated by a first actuation means arranged on the side of the large lateral wheel.

The obtained technical effect is that one side of the wheelchair is freed from the lateral drive wheel and its associated actuation means, so as to allow a throwing movement to be performed without any risk for the wheelchair's user, while at the same time maintaining the movement potential of a conventional wheelchair.

Optionally, the present invention further comprises at least one of the following features:
the small lateral wheel is arranged so as to be on the side of the connection piece opposite to the side facing toward the large lateral wheel;
the small lateral wheel is disposed in a location closer to the large lateral wheel than the location of the connection piece with which it is associated;
the kit comprises a second actuation means such as a handrim for actuating and controlling the large lateral wheel;
the second actuation means of the large lateral wheel is made directly integral with its wheel, the drive means being provided between the first actuation means of the small lateral wheel and the small lateral wheel;
the first and second actuation means are concentric;
the drive means comprise transmission means such as a reduction gear box or a set of reduction pinions;
the kit includes means for varying its length in the form of a shaft provided with a first tube (27) slidable inside a second tube (26), the first tube (27) being connected to one of the wheels (42) and the second tube (26) being connected to the other wheel (10);
the drive means include a rod extending between the large lateral wheel and the small lateral wheel, the set of reduction pinions comprising a first pinion and a second pinion, the first pinion being of a smaller diameter than the second pinion, the pinions meshing either directly or indirectly;
the second pinion is located at the end of the rod adjacent to the large wheel, the other end of the rod being connected to the axle of the small lateral wheel, the first pinion being connected to the portion of the drive means passing freely through the centre of the large lateral wheel, the first and second pinions meshing through a belt or a chain;
the second pinion of the small lateral wheel, and said lateral wheel, are concentric, the first pinion being provided at the end of the rod adjacent to the small lateral wheel, the end of the rod adjacent to the large lateral wheel being provided with a first intermediate pinion meshing with a second intermediate pinion connected to the portion of the drive means;
the connection piece of the small lateral wheel is in the form of a bracket, said bracket carrying at one of its ends the small lateral wheel, with the small wheel being free to rotate with respect to the bracket;
the connection piece of the small lateral wheel is in the form of an upper connection piece and a lower connection piece, the connection pieces having an end adjacent to each other, an articulation axis being provided between the upper and lower connection pieces, the small wheel being free to rotate with respect to the other end of the lower connection piece;
the small lateral wheel and its connection piece can be mounted at either of the longitudinal ends of the kit.

The present invention also relates to a manual wheelchair comprising a seat extending from one lateral side of the wheelchair to the other, characterized in that it comprises such a wheel kit.

Advantageously the small lateral wheel is associated with an anti-tip bracket provided with a stabilizer wheel.

Advantageously the small lateral wheel is associated with a cover surrounding at least its external face, the lower part of the cover being provided with a stabilizer wheel.

Advantageously an auxiliary large lateral wheel is associated to the small lateral wheel at the same side of the wheelchair, the small lateral wheel being associated with a clutch in order to disable the small lateral wheel.

Other features, aspects and advantages of the present invention will become apparent upon reading the following detailed description and with reference to the appended drawings given as non-limiting examples, in which:

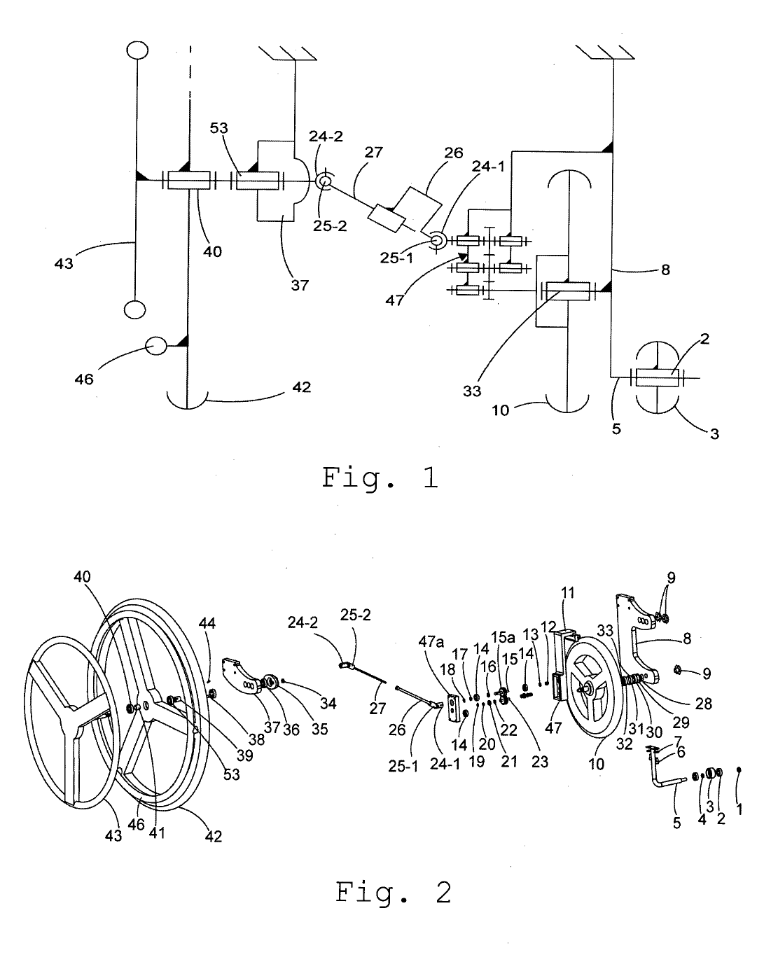

FIG. 1 is a schematic drawing of the principle kinematics of a lateral drive wheel kit for a manual wheelchair according to the present invention;

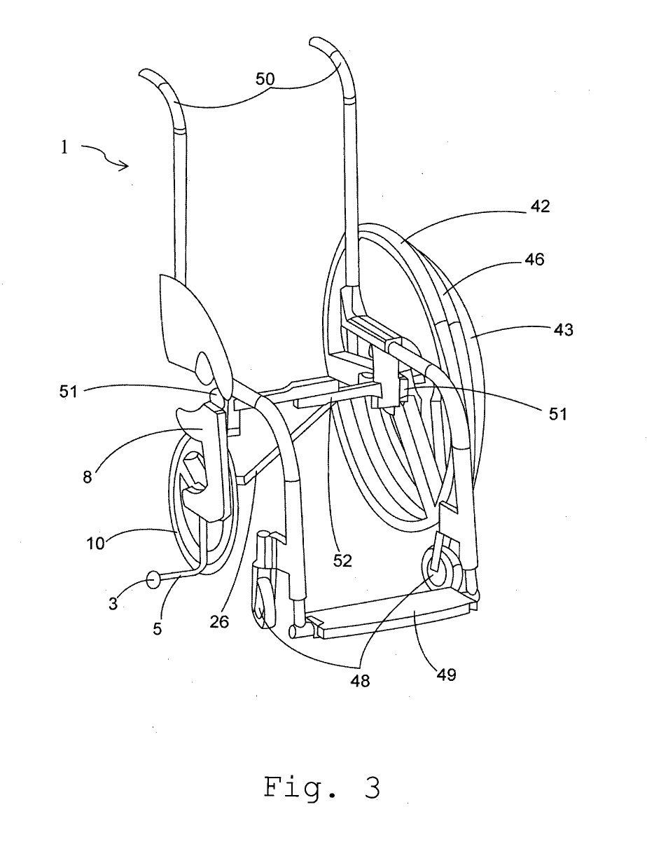

FIG. 2 is a schematic drawing of an exploded perspective view of the wheel kit according to the present invention;

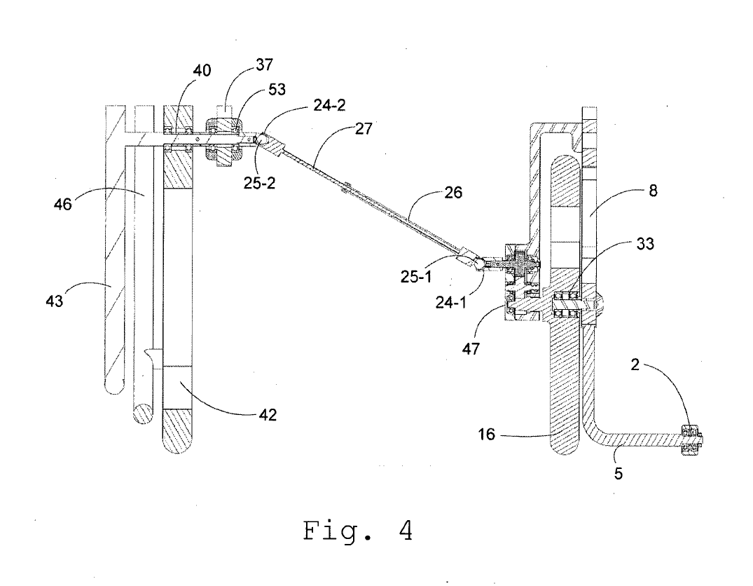

FIG. 3 is a schematic drawing of a perspective view of a wheelchair frame dedicated to the practice of sports and provided with a wheel kit according to a first embodiment of the present invention,

FIG. 4 is a sectional view of the wheelchair according to the first embodiment of the present invention,

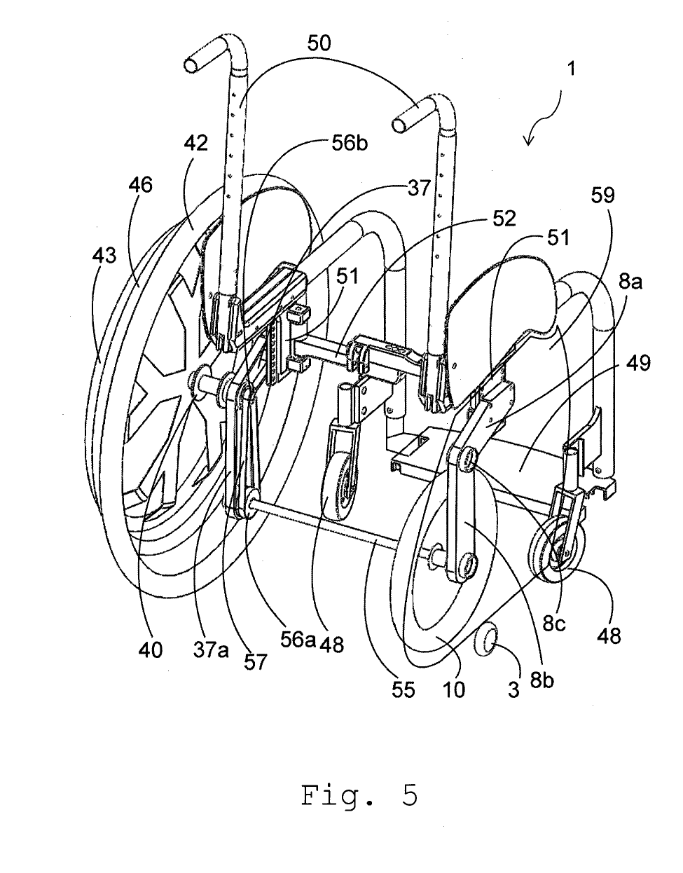

FIG. 5 is a schematic drawing of a perspective view of a wheelchair frame dedicated to the practice of sports and provided with a wheel kit according to a second embodiment of the present invention,

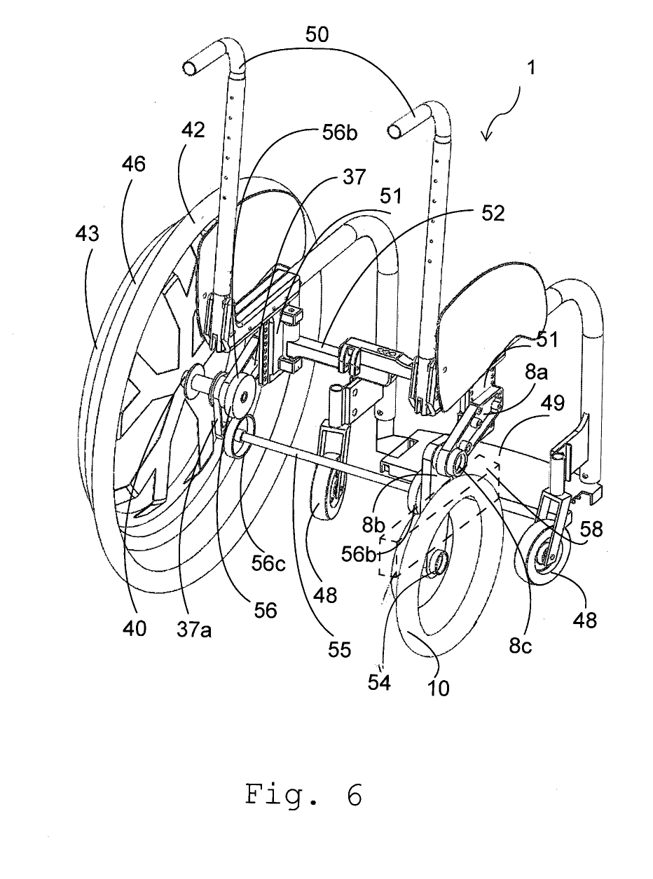

FIG. 6 is a schematic drawing of a perspective view of a wheelchair frame dedicated to the practice of sports and provided with a wheel kit according to a third embodiment of the present invention.

FIGS. 1 to 4 refer to a first embodiment according to the invention. A wheel kit for a manual wheelchair 1 is shown, in which the operational principle of the present invention is applied. This manual wheelchair 1 has two lateral wheels 10 and 42 of different sizes, both of which are drive wheels, these lateral wheels 10 and 42 being mounted non-coaxially because of their different sizes, for example, without this being limiting, 26 inches for the large lateral wheel 42, and 10 inches for the small wheel 10.

As shown in FIGS. 1 to 4, the small lateral wheel 10 is retracted underneath the manual wheelchair's seat, with the members 8 and 37 defining the lateral sides of the wheelchair 1. These members 8 and 37 are connection members provided near to each wheel 10, 42 for connecting the kit to the wheelchair 1. On the side of the small lateral wheel 10, the connection piece is in the form of a wheel bracket 8, this bracket 8 defining the most lateral sidewall of the wheelchair 1 on the side of the small lateral wheel 10. The bracket 8 supports the axle 33 of the small lateral wheel 10.

The large lateral drive wheel 42 has a first 43 and a second (46) actuation means, said actuation means being, for example, handrims, which propel the wheelchair 1 when rotated by the user's hand. The first actuation means 43 is associated with the small lateral drive wheel 10 and the second actuation means 46 is associated with the large lateral wheel 42. Thus, the lateral side of the wheelchair 1, which is associated with the small lateral wheel 10, is entirely unobstructed, thereby facilitating the throwing action of the user's arm.

The forces exerted on the second actuation means 46, referred to as the inner actuation means, are transmitted directly to the large lateral wheel 42, this actuation means 46 being connected directly to the large lateral wheel 42 by being made integral with the latter. The inner actuation means 46 is concentric with the large lateral wheel 42 and has a slightly smaller diameter.

The first actuation means 43, referred to as the outer actuation means, which is associated with the small lateral wheel 10, is arranged so as to be the outermost actuation means with respect to the manual wheelchair 1, by being concentric with the large lateral wheel 42 and the inner actuation means 46. Advantageously, the outer actuation means 43 has a smaller outer diameter than the inner actuation means 46 so as to allow access to this inner actuation means 46.

Drive means 24-1, 24-2, 25-1, 25-2, 26, 27, 40 are provided between the outer actuation means 43 and the small wheel 10 associated with it, these drive means being actuated by the actuation means 43 arranged on the side of the large lateral wheel 42. These drive means will be discussed in more detail below. In one embodiment of the invention, these drive means comprise first and second gimbal bodies 26, 27, each gimbal body 26, 27 comprising at each of their extremities a ball end 25-1, 25-2, one of the ball end 25-2 being located on the side of the large lateral wheel 42 while the other ball end 25-1 being located on the side of the small wheel 10.

Each of these ball ends 25-1, 25-2 cooperates with one extremity tip 24-1, 24-2. A shaft connects the outer actuation means 43 to the ball end 25-2, the shaft extending through the large lateral wheel 40 and a support 37 connected to the chair. The drive means include pieces 40 and 53 are under the form of bearings. A first bearing 40 permits the shaft to traverse through the large lateral wheel 42 by passing freely through the centre of the large lateral wheel 42 without interfering with the movement of said large wheel 42 and without restricting the rotational capacity of the outer actuation means 43 about the axle of the large lateral wheel 42. A second bearing 53 permits the shaft of the outer actuation means 43 to traverse a support affixed to the wheel chair, this support being advantageously under the form of a bracket 37, the second bearing 53 being associated with a spacer 39.

The large lateral wheel 42 and the inner and outer actuation means 46 and 43 thus rotate about a common axle, with a bearing 40 being provided between this axle and the large lateral wheel 42, this axle being supported by a large wheel bracket 37, which serves as a connection piece, by extending below the seat on the lateral side of the wheelchair 1.

The drive means for transmitting the force exerted on the outer actuation means 43 to the small lateral wheel 10 comprise a telescopic shaft 26 and 27 comprising a first gimbal body 27 arranged on the side of the large lateral wheel 42 and a second gimbal body 26 arranged on the side of the small lateral wheel 10, wherein the gimbal body 27 can be inserted into the gimbal body 26, although the reverse is also possible, and the first and second gimbal bodies 26, 27 form means for varying the length of the wheel kit.

Each gimbal body 26 and 27 is provided, at its outermost end, that is, the end facing the large lateral wheel 42 for the first gimbal body 27, and that facing the small lateral wheel 10 for the second gimbal body 26, with a gimbal tip 24-1, 24-2 which cooperates with respectively a ball end 25-1, 25-2, these members 24-1, 24-2 and 25-1, 25-2 forming the joints of the first and second gimbal bodies 26, 27. The drive means also comprise a reduction gear box 47.

The reduction gear box 47 serves to compensate for the difference in size between the outer actuation means 43 and the small lateral wheel 10. The output shaft of this reduction gearbox drives a pinion shaft on the axle 33 of the small lateral wheel 10.

Advantageously, although this is not required, an anti-tip bracket 5 can be provided, which carries a stabilizer wheel 3 which rotates about one axis and is provided with a bearing 2, the stabilizer wheel 3 having an even smaller diameter than the small lateral wheel 10. This anti-tip bracket 5 advantageously extends from the lower edge of bracket 8 towards the ground, on the lateral side of the wheelchair 1 from which the small lateral wheel 10 has been retracted, this small wheel 10 now being located under the wheelchair 1 seat, thus making it less cumbersome during a throwing movement performed by the wheelchair 1 user's arm on this lateral side of the wheelchair 1. This anti-tip bracket 5 provides more stability on this lateral side of the wheelchair 1 by compensating for the reduction in size of the small lateral wheel 10. This bracket 5 can be provided for all the three embodiments of the wheelchair 1 according to the present invention. Alternatively the bracket can be replaced by a cover 59 as shown in FIG. 5.

Advantageously, the anti-tip bracket 5 is bent at a right angle, with its first highest portion being substantially vertical and its second portion being horizontal, the second portion being located close to the ground by carrying the stabilizer wheel 3 which rolls on the ground, towards its free end. The anti-tip bracket 5 therefore does not represent an obstruction to the movement of the arm of the wheelchair 1 occupant performing a throwing movement.

FIG. 2 shows an exploded view of the various members composing the asymmetrical wheel kit according to the present invention while FIG. 4 shows a sectional view of the wheelchair according to the present invention. Starting from the lateral side of the wheelchair which is not provided with the small lateral wheel 10, the asymmetrical wheel kit comprises the outer actuation means 43 for remotely driving the small lateral wheel 10. A bearing 40 is then provided on the axle of the outer actuation means 43 together with a spacer 41 inserted into the axle housing for the outer actuation means 43, a bearing and a spacer 41 being inserted into the axle housing for the inner actuation means 46, and a bearing 40 and a spacer 48, for the large lateral wheel 42.

Advantageously, quick mounting means 44, in particular of the pin type, are provided, thus facilitating assembly and disassembly of the various afore-mentioned members, namely the actuation means 43 and 46, and the large lateral wheel 42. Advantageously, on the other lateral side of the asymmetrical wheel kit, as will be detailed below, finger nuts 9 are provided for making the asymmetrical wheel kit integral with the manual wheelchair 1, this being performed by means of the bracket 8. The pin 44 and nuts 9 allow for quick and easy assembly and disassembly of the asymmetrical wheel kit.

A bracket 37 arranged on the side of the large lateral wheel 42 serves for the purposes of fitting the asymmetrical wheel kit onto this lateral side of the wheelchair 1. This bracket 37 is combined with a bearing 36 accommodated in a casing 36 and a tightening nut 34.

The next members are the gimbal bodies 26 and 27 with their gimbal tips 24-1, 24-2 and the ball end 25-1, 25-2 at each of their ends, as has already been mentioned.

Since the gimbal bodies 26, 27 can penetrate to a greater or lesser extent into one another, the width of the asymmetrical wheel kit can be adapted to many different types of width of manual wheelchair 1.

At its gimbal tip 24-2 facing the small lateral wheel 10, the gimbal body 26 is connected to members intended to be enclosed within the gear box 47, whose cover 47a is shown at a distance from box 47. The reduction gearbox 47 comprises bearings 14, an elastic ring 18, spacers 13, 16 and 17 of different sizes, a set of pinions 15a with an output shaft 15 and a nut 12. The reduction gearbox 47 is mounted on an arm 11, this arm 11 having a curved end forming the body of gearbox 47.

The small lateral wheel 10 has an axle 33, one end of which faces the gearbox 47 for the purposes of driving the latter, said axle 33 carrying two bearings 30 and 32, one spacer 31, a snap ring 29 and a tapered spacer 28, the axle 33 being carried by a connection bracket for the small wheel, which is integral with the wheelchair 1, ergonomic nuts 9 being provided for making the connection bracket 8 integral with the wheelchair 1 and maintaining the various members 28 to 33 in their operating position.

The anti-tip bracket 5, which carries a stabilizer wheel rotating around an axle and which is in contact with the ground, with the bracket 5 being arranged on the lateral side of the wheelchair 1 where the small lateral wheel 10 is retracted under the wheelchair's seat, has a screw 6, a washer 7, a spacer 4, a bearing 2 and a locking nut 1.

In FIG. 3, a wheelchair 1 frame is shown, with the frame carrying the asymmetrical wheel kit according to the present invention.

Conventionally, a manual wheelchair 1 may comprise a cross-brace 52 connecting the right lateral side of the wheelchair 1 to its left lateral side. This cross-brace 52 is advantageously comprised of two parts and can be articulated in its longitudinal midsection so that the wheelchair 1 is foldable with its lateral sides advancing towards each other or even being brought into to contact with one another. The wheelchair 1 can still be easily folded and disassembled so as to be carried in a car, train, airplane, etc.

The cross-brace 52 carries at each of its longitudinal ends a block 51 which is advantageously used for fitting the lateral wheels 10, 42 of the wheelchair 1, which ensure the propulsion of the wheelchair 1 through actuation of the respective actuation means 43, 46 by a user's hand.

Conventionally, the two lateral drive wheels 10, 42 are of equal size, with their axle being located at block 51. This is not the case for the wheel kit according to the present invention for which both lateral wheels are asymmetrical, with a small lateral wheel 10 and a large lateral wheel 42. As a result of both the small and large wheels 10, 42 touching the ground, the axle of the small wheel 10 cannot be at the same height as block 51, but is located at a lower level. To make the small lateral wheel integral with its lateral side which is associated with the wheelchair 1, whilst the small lateral wheel 10 remains freely rotatable with respect to the wheelchair 1, the present invention uses bracket 8, of which a portion, advantageously the upper end portion, is connected to the most lateral portion of block 51 and of which another portion, advantageously a lower end portion, supports the small lateral wheel 10.

According to the first embodiment of the present invention, as has also been seen in FIGS. 1 and 2, the small lateral wheel 10 is located on the side of its bracket 8 facing the large lateral wheel 42, that is to say, the small lateral wheel 10 is closer to the large lateral wheel 42 than its associated bracket 8. This is not limitative for the present invention since the small lateral wheel 10 can be located on the other side of its bracket as shown in FIGS. 5 and 6 for the second and third embodiments of the present invention, embodiments which will be later described.

When the asymmetrical wheel kit according to the present invention is fitted to the manual wheelchair 1, as shown in FIG. 3, since bracket 8 is attached to the most lateral part of block 51 and since the small lateral wheel 10 is located on the side of bracket 8 facing the large lateral wheel 42, the small lateral wheel 10 can be retracted underneath the manual wheelchair 1 and no longer protrudes from its lateral side associated with the wheelchair 1.

FIGS. 5 and 6 show respectively second and third embodiments of the wheel kit according to the present invention.

According to FIGS. 1 to 6, the three embodiments concern a wheel kit which includes two asymmetrical wheels, with a small lateral wheel 10 and a large lateral wheel 42, the small lateral wheel 10 being provided with drive means 24-1, 24-2, 25-1, 25-2, 26, 27, 40, 47; 55, 56a, 56b, 54, a portion 40 of the drive means 24-1, 24-2, 25-1, 25-2, 26, 27, 40, 47; 55, 56a, 56b, 54 passing freely through the centre of the large lateral wheel 42.

The second and third embodiments differ firstly from the first embodiment of the wheel kit in that the small lateral wheel 10 is arranged so as to be on the other side of the connection piece 8b, 8c than those facing the large lateral wheel 42. In these embodiments the small lateral wheel 10 can be covered at least at its upper part by a protection hood 58 avoiding the hand of person sitting in the wheel chair to come into contact with the small lateral wheel 10.

The protection hood 58 is shown in dotted lines in FIG. 6 illustrating the third embodiment. In FIG. 5 the stabilizer wheel 3 is shown without an anti-tip bracket previously referenced 5 in FIGS. 3 and 4. The anti-tip bracket is replaced by a cover 59 surrounding at least the external face of the small lateral wheel 10, the lower part of the cover being provided with the stabilizer wheel 3. The cover 59 is advantageously transparent and can be made of a material like Plexiglas®.

The second and third embodiments differ secondly from the first embodiment of the wheel kit in that the drive means comprise a set of reduction pinions 54, 56a, 56b instead of including a reduction gear box. The actuation means 46 of the large lateral wheel 42 and the actuation means 43 of the small lateral wheel 10 and their location remain however unchanged in respect of the first embodiment of the wheel kit.

In the second and third embodiments, as it can be viewed in FIGS. 5 and 6, the drive means include a rod 55 extending between the large lateral wheel 42 and the small lateral wheel 10. The set of reduction pinions comprises a first pinion 56b and a second pinion 56a, 54, the first pinion 56b being of a smaller diameter than the second pinion 56a, 54, the pinions 54, 56a, 56b meshing either directly or indirectly.

In FIG. 5 the rod 55 extends according to the axle of the small lateral wheel 10 while in FIG. 6 the rod 55 extends parallel to the axle of the small lateral wheel 10 above this axle.

FIG. 5 shows a second pinion 56a located at the end of the rod 55 adjacent to the large lateral wheel 42, the other end of the rod 55 being connected to the axle of the small lateral wheel 10. The first pinion 56b can be connected to the portion 40 of the drive means passing freely through the centre of the large lateral wheel 42, the first and second pinion 56a, 56b meshing through a belt or a chain 57.

FIG. 6 shows a second pinion 54 located on the axle of the small lateral wheel 10, the first pinion 56b being provided at the end of the rod 55 adjacent to the small lateral wheel 10. The end of the rod 55 adjacent to the large lateral wheel 42 is provided with a first intermediate pinion 56c meshing with a second intermediate pinion 56 connected to the portion 40 of the drive means passing freely through the centre of the large lateral wheel 42. The first and second pinions 56b, 54 on one side and the first and second intermediate pinions 56, 56c on the other side mesh respectively directly. Advantageously, the first and second intermediate pinions 56, 56c are of the same diameter.

In respect of FIGS. 5 and 6, the connection pieces 8a, 8b, 37, 37a provided near to each lateral wheel 10, 42 for connecting the kit to a respective lateral side of the wheelchair 1 are different from the connection pieces of the first embodiment.

For the second and third embodiments, the connection piece of the small lateral wheel 10 is in the form of an upper connection piece 8a and a lower connection piece 8b. The connection pieces 8a, 8b have an end adjacent to each other, an articulation axis 8c being provided between the upper and lower connection pieces 8a, 8b, the axle of the small lateral wheel 10 being supported by the other end of the lower connection piece 8b and free to rotate with respect to this lower connection piece 8b.

For the second and third embodiments, the connection piece of the large lateral wheel 42 is in the form of a connection piece 37 which can be similar of a bracket according to the first embodiment arranged on the side of the large lateral wheel 42. This bracket is combined with a bearing accommodated in a casing and a tightening nut for the extension of the portion 40 of the drive means passing freely through the centre of the large lateral wheel 42.

The connection piece 37 comprises an extension piece 37a supporting the associated end of the rod 55, the end of the rod 55 being provided with a first reduction pinion 56a, as shown in FIG. 5 or an intermediate pinion 56c as shown in FIG. 6.

According to the previously described embodiments, the small lateral wheel 10 no longer forms an obstruction for the user's arm when the arm follows a path along the lateral side of the wheelchair 1. According to the first embodiment, this lateral wheel 10 is arranged so as to be on the other side closer to the large lateral wheel 42 than the connection piece 8, 8a, 8b with which it is associated.

According to the second and third embodiments, although the small lateral wheel 10 is arranged so as to be on the other side of the connection piece 8a, 8b than those facing the large lateral wheel 42, the small lateral wheel 10 is covered at least at its upper part by a protection hood 58 avoiding the hand of person sitting in the wheel chair to come into contact with the small lateral wheel 10.

The size of the small lateral wheel 10 is chosen to be large enough to provide good stability to the wheelchair 1 while being small enough to be easily retracted under the seat. As previously stated, an anti-tip bracket 5 with a stabilizer wheel can be provided to increase the wheelchair's stability on the lateral side carrying the small lateral wheel 10.

In the usual manner, the wheelchair 1 comprises in its lower front portion a footrest 49 as well as two non-driving small front wheels 48 which are advantageously mounted freely to provide even more stability to the entire wheelchair 1. Similarly, the wheelchair 1 can be provided at its upper rear portion with handles 50 that are raised with respect to the wheelchair 1, so that an assistant can move the wheelchair 1 and its occupant. In addition, the manual wheelchair 1 may be provided with armrests, with each of the wheelchair occupant's arms resting on their respective armrest. These elements are not necessarily required and wheelchairs are available for athletes, the number of parts thereof being minimized in order to increase aerodynamics and reduce the weight of the wheelchair 1.

The wheel kit according to the present invention can advantageously be adapted to most of the wheelchairs available on the market, while remaining affordable in comparison with the purchase of a wheelchair specifically dedicated to a sport.

Such a wheelchair can be used with its original wheels and the wheels from the kit according to the present invention. The wheel kit is entirely symmetrical, which allows the small wheel to be placed on either the right or the left. The fitting of such a wheel kit to a wheelchair is quick and simple and the wheel kit can be adapted to any wheelchair width while providing the same stability as that obtained in conventional usage, as well as a substantially preserved ease of movement, while the steering and propulsion control of the wheelchair can be preserved at all times by the user.

Optionally an auxiliary large lateral wheel is associated to the small lateral wheel at the same lateral side of the wheelchair, the small lateral wheel being associated with a clutch connecting the small lateral wheel with the drive means and rendering it inoperative by clutching out.

This permits the wheel chair to function normally when a sport activity is not practised, the clutch being clutched out and to adapt the wheel chair to the practise of a sport activity by dismounting the large lateral wheel associated on the same side of the wheel chair than the small lateral wheel and rendering the small lateral wheel driven by the associated drive means by clutching in the clutch.

Advantageously, during the use of the auxiliary large lateral wheel when a sport activity is not practised, the small lateral wheel is retractable in a position in which it does not contact the ground and can therefore not impair the function of the auxiliary large lateral wheel.

1. A wheel kit for forming the lateral drive wheels of a manual wheelchair, the kit comprising:
a wheel arranged towards longitudinal ends of the kit, a connection piece being provided near to the wheel for connecting the kit to a respective lateral side of the wheelchair, and
two asymmetrical wheels including a small lateral wheel and a large lateral wheel, the small lateral wheel being provided with drive means actuated by a first actuation means arranged on a side of the large lateral wheel.

2. The wheel kit according to claim 1, wherein the small lateral wheel is arranged so as to be on a side of the connection piece opposite to a side facing toward the large lateral wheel.

3. The wheel kit according to claim 1, wherein the small lateral wheel is disposed in a location closer to the large lateral wheel than a location of the connection piece with which the small lateral wheel is associated.

4. The wheel kit according to claim 1, which comprises a second actuation means such as a handrim for actuating and controlling the large lateral wheel.

5. The wheel kit according to claim 4, wherein the second actuation means of the large lateral wheel is directly integral with the large lateral wheel, the drive means being provided between the first actuation means of the small lateral wheel and the small lateral wheel.

6. The wheel kit according to claim 5, wherein the first and second actuation means and the large lateral wheel are concentric.

7. The wheel kit according to claim 4, wherein the drive means comprises transmission means such as a reduction gear box or a set of reduction pinions.

8. The wheel kit according to claim 1, wherein the drive means comprises means for varying a length of the drive means in the form of a shaft provided with a first tube slidable inside a second tube, the first tube being connected to one of the wheels and the second tube being connected to the other wheel.

9. The wheel kit according to claim 7, wherein the drive means comprises a rod extending between the large lateral wheel and the small lateral wheel, the set of reduction pinions comprising a first pinion and a second pinion, the first pinion being of a smaller diameter than the second pinion, the first and second pinions meshing either directly or indirectly.

10. The wheel kit according to claim 9, wherein the second pinion is located at an end of the rod adjacent to the large lateral wheel, the other end of the rod being connected to an axle of the small lateral wheel, the first pinion being connected to a portion of the drive means passing freely through a center of the large lateral wheel, the first and second pinions meshing through a belt or a chain

11. The wheel kit according to claim 9, wherein the second pinion of the small lateral wheel, and said small lateral wheel, are concentric, the first pinion being provided at the end of the rod adjacent to the small lateral wheel, the end of the rod adjacent to the large lateral wheel being provided with a first intermediate pinion meshing with a second intermediate pinion connected to the portion of the drive means.

12. The wheel kit according to claim 1, wherein the connection piece of the small lateral wheel is in the form of a bracket, said bracket carrying at one of its ends the small lateral wheel with the small lateral wheel being free to rotate with respect to the bracket.

13. The wheel kit according to claim 1, wherein the connection piece of the small lateral wheel is in the form of an upper connection piece and a lower connection piece, the upper and lower connection pieces having an end adjacent to each other, an articulation axis being provided between the upper and lower connection pieces, the small lateral wheel being free to rotate with respect to the other end of the lower connection piece.

14. The wheel kit according to claim 1, wherein the small lateral wheel and the connection piece are mounted at either of the longitudinal ends of the kit.

15. A manual wheelchair comprising a seat extending from one lateral side of the wheelchair to the other, wherein the manual wheelchair comprises the wheel kit according to claim 1.

16. The manual wheelchair according to claim 15, wherein the small lateral wheel is associated with an anti-tip bracket provided with a stabilizer wheel.

17. The manual wheelchair according to claim 15, wherein the small lateral wheel is associated with a cover surrounding at least an external face of the small lateral wheel, a lower part of the cover being provided with the stabilizer wheel.

18. The manual wheelchair according to claim 15, wherein the large lateral wheel is associated to the small lateral wheel at the same side of the wheelchair, the small lateral wheel being associated with a clutch in order to disable the small lateral wheel.

19. The wheel kit according to claim 2, which comprises a second actuation means such as a handrim for actuating and controlling the large lateral wheel.

20. The wheel kit according to claim 3, which comprises a second actuation means such as a handrim for actuating and controlling the large lateral wheel.
